(19) United States
(12) Patent Application Publication
(10) Pub. No.: US 2025/0205944 A1
(43) Pub. Date: Jun. 26, 2025

(54) METHOD OF MOLDING A DEVICE WITH A FASTENER RELEASABLY SECURED IN AN INTEGRAL FASTENER HOLDER

(71) Applicant: Sioux Chief Mfg. Co., Inc., Kansas City, MO (US)

(72) Inventors: Brian E. Ismert, Belton, MO (US); Cory Adams, Raymore, MO (US); Jeremiah T. Winnat, Garden City, MO (US)

(73) Assignee: Sioux Chief Mfg. Co., Inc., Kansas City, MO (US)

(21) Appl. No.: 18/962,081

(22) Filed: Nov. 27, 2024

Related U.S. Application Data
(60) Provisional application No. 63/612,585, filed on Dec. 20, 2023.

(51) Int. Cl. B29C 45/14; B25C 3/00; B29C 45/26

(52) U.S. Cl. CPC B29C 45/14008; B25C 3/006; B29C 45/2602

(57) ABSTRACT

A method of molding a hanger having one or more fastener holders with a fastener releasably molded in each of the one or more fastener holders includes providing a mold having one or more cavities configured to define one or more hangers integrally formed with one or more fastener holders, providing a fastener receiving chamber associated with each fastener holder, and providing means for maintaining each fastener in position in the corresponding fastener receiving chamber. The method of molding the device further includes feeding a fastener into each of the one or more fastener receiving chambers of the mold and positioning the fastener relative to the means for maintaining a fastener in position in the chamber.

### CROSS-REFERENCE TO RELATED APPLICATIONS

This application claims the benefit of U.S. Provisional Patent Application No. 63/612,585, filed Dec. 20, 2023, the disclosure of which is incorporated herein in its entirety by reference.

### BACKGROUND OF THE INVENTION

### Field of the Invention

This invention relates to a device with an integral fastener holder and a method of manufacture of such a device.

### Background

A molded device or part may include a fastener retaining structure, such as tabs or brackets, for temporarily retaining a fastener, such as a screw, that is to be used in installation or assembly of the component and for a user's convenience to expedite installation or assembly. Current processes include a secondary process to pair the screw with the component, which may include a manual process in which a person places or presses the screw into the retaining structure, or an automated process in which a bowl feeder orients and feeds the screw to a mechanical arm for installation into the component.

The secondary process of pairing the screw with the component requires substantial resources, including secondary equipment to accomplish the pairing, as well as systematic monitoring of the supplied screw and the molded retaining structure to ensure that dimensional tolerances of the screw and the retaining structure are met such that the screw is not lost in storage or transit. The secondary process increases equipment costs, personnel costs, and the time required for production of each component with the paired screw. Further, due to the secondary process, the likelihood of an issue causing congestion in the overall process is increased.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The embodiments described herein relate to a method of molding a device to be distributed with one or more fasteners. The method includes providing a mold having one or more cavities configured to define the device and one or more fastener holders integrally formed therewith. The method further includes providing one or more fastener receiving chambers formed in the mold that are configured to contain the one or more fasteners. Still further, the method includes feeding the one or more fasteners into the one or more fastener receiving chambers. Yet still further, the method includes injecting a material into the mold subsequent to feeding the one or more fasteners into the one or more fastener receiving chambers, such that the one or more fasteners are releasably molded therein.

The embodiments described herein relate to a method of molding a device to be distributed with one or more fasteners. The method includes separating a first mold plate and a second mold plate of a mold. In an embodiment, the first mold plate and the second mold plate form one or more cavities configured to define the device and one or more fastener holders integrally formed therewith when the first and second mold plates are advanced into abutting relationship. A first portion of one or more fastener receiving chambers is formed in the first mold plate and configured to receive the one or more fasteners when the first and second mold plates are separated, and a second portion of the one or more fastener receiving chambers is formed in the second mold plate. When the first and second mold plates are advanced into abutting relationship, each of the one or more fastener receiving chambers extends through and opens into the one or more cavities configured to define the one or more fastener holders. The method further includes feeding the one or more fasteners into the first portion of each of the one or more fastener receiving chambers when the first and second mold plates are separated. Still further, the method includes advancing the first and second mold plates into abutting relationship. Still further, the method includes injecting a plastic material into the one or more cavities of the mold to form the device and the one or more fastener holders integrally formed therewith, such that the one or more fasteners are releasably molded in the one or more fastener holders. The method further includes advancing the first and second mold plates to a separated position. Yet still further, the method includes ejecting from the mold the device with the one or more fasteners secured in the one or more fastener holders integrally formed with the device.

The embodiments described herein relate to a device having a fastener molded therein. The device includes a hanger configured to support a conduit and one or more fastener holders extending from the hanger and formed integrally therewith. The one or more fastener holders include one or more fasteners releasably molded therein during a molding process.

The embodiments described herein relate to a mold for forming a device with a fastener. The mold includes a first mold plate having a first portion of one or more fastener receiving chambers formed therein and configured to receive one or more fasteners and a second mold plate having a second portion of the one or more fastener receiving chambers formed therein. When the first and second mold plates are advanced into abutting relationship, each of the one or more fastener receiving chambers extends therethrough and opens into one or more fastener holder cavities configured to define one or more fastener holders that are formed around the one or more fasteners during a molding process.

### BRIEF DESCRIPTION OF THE DRAWINGS

Embodiments of the invention are described in detail below with reference to the attached drawing figures.

FIG. 1 is a perspective view an embodiment of a hanger having fastener holders integrally molded therewith, and fasteners releasably molded therein. The view is of a first side of the hanger.

FIG. 2 is a perspective view of a second side of the hanger in FIG. 1 with the fasteners removed to show the fastener holders, including a slot formed in each of the fastener holders through which the fasteners are releasable.

FIG. 3 is a fragmentary view of the fastener holders shown in FIG. 1.

FIG. 4 is a perspective view of an embodiment of a hanger having a fastener holder integrally molded therewith, and a fastener releasably molded therein.

FIG. 5 is an elevation view of the hanger shown in FIG. 4.

FIG. 6 is a perspective view of a first mold plate of a mold for the hanger shown in FIG. 1.

FIG. 7 is a fragmentary view of the first mold plate of the mold shown in FIG. 6 and includes a chamber that contains one of the fasteners, magnets secured in receptacles and that extend around a portion of the fastener, and a core that is adjacent the fastener and corresponds to the slot formed in the fastener holder molded around the fastener.

FIG. 8 is a cross-sectional view along line 8-8 of the first mold plate shown in FIG. 6, showing a cross section of a raised section that forms a cavity in which the hanger is formed.

FIG. 9 is a cross-sectional view along line 9-9 of the second mold plate shown in FIG. 10, showing a cross section of a recessed section that forms the cavity in which the hanger is formed.

FIG. 10 is a perspective view of a second mold plate of the mold for the hanger shown in FIG. 1.

FIG. 11 is a fragmentary view of the second mold plate of the mold shown in FIG. 10 and includes a chamber for containing the fastener, receptacles for the magnets, and a cavity of the fastener holder, including a connecting structure and a cradle.

FIG. 12 is a cross-sectional view along line 12-12 of the first mold plate shown in FIG. 6, showing a cross section of a portion of the chamber formed therein for receiving and containing the fastener that is shown secured in the chamber.

FIG. 13 is a cross-sectional view along line 13-13 of the second mold plate shown in FIG. 10, showing a cross section of a portion of the chamber formed therein for containing the fastener.

FIG. 14 is a block diagram representing an embodiment of an exemplary process of molding a device having one or more fastener holders integrally molded therewith and one or more fasteners releasably molded therein, as shown in FIGS. 1 and 4.

The drawing figures do not limit the invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

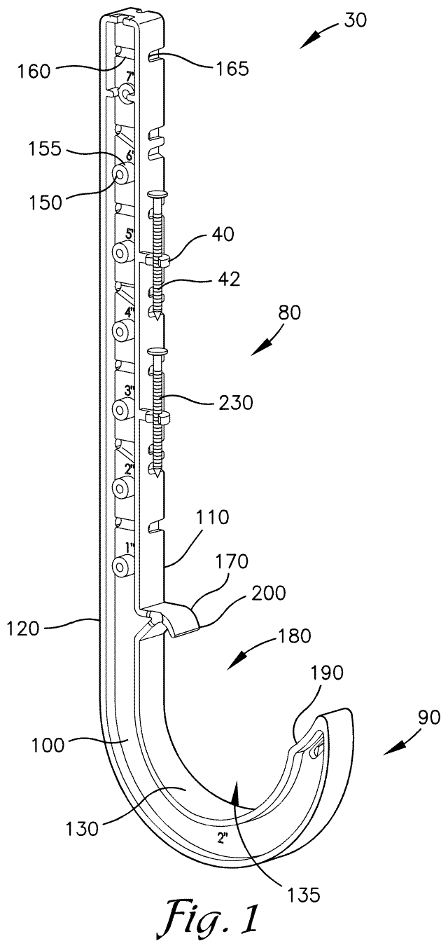

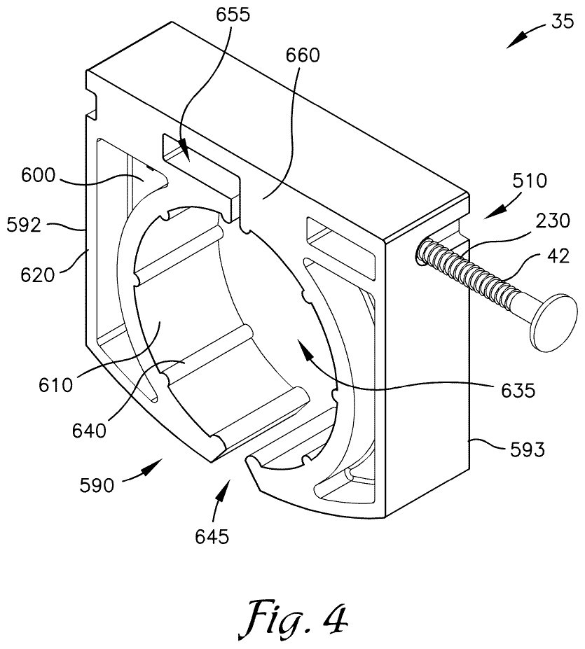

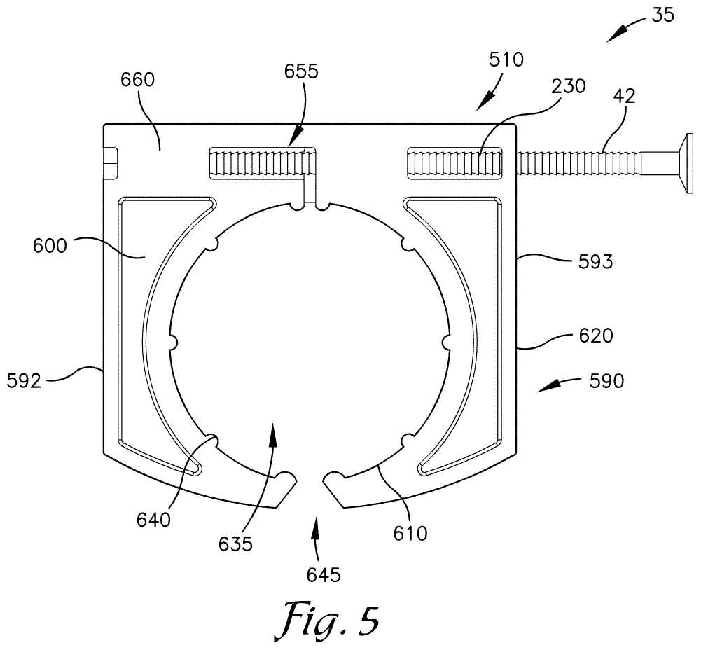

In embodiments described herein, a device having a fastener holder that includes a fastener preloaded or releasably molded into the fastener holder and a method or process of molding the same are disclosed. In an embodiment, the fastener holder is formed around a fastener and integrally with the device or article of manufacture formed in a molding process. The device may be utilized in construction installations, such as, for example, plumbing and/or electrical installations for supporting conduit, such as piping, tubing, or cables. The fastener is molded into the fastener holder during the molding process and is intended to be used with the device and may comprise, for example, a screw, a nail, or a bolt for coupling the device to a substrate such as a floor joist or a beam or other structural support. The fastener is preferably formed from a ferromagnetic material such as steel. Examples of devices used in installations with at least one integrally formed fastener holder having at least one fastener releasably molded therein are shown in the drawings and include conduit hangers, such as a J-hanger 30 shown in FIGS. 1-3 and a tubing hanger 35 shown in FIGS. 4-5. In an embodiment, the hangers 30 and 35 and the integrally formed fastener holders are molded utilizing an injection molding process that utilizes molten plastic, but it is foreseeable that another manufacturing process and/or material may be used to form the hangers 30 and 35 with the fastener releasably installed within the fastener holder during the manufacturing process. It is foreseeable that one or more integrally formed fastener holders having a fastener releasably molded therein may be utilized in a variety of devices for installation outside of the scope of construction and that require a fastener.

The fastener holder functions to contain the fastener during production, transportation and storage. Molding a device to include a fastener holder with a fastener releasably molded therein eliminates one or more steps of preparing the device for a consumer, including pairing the fastener with the device. Specifically, a secondary process is eliminated that includes one or more steps of packaging the fastener with the device or loading the fastener in the device, which provides savings in at least production costs, space allocation on a production floor, and time.

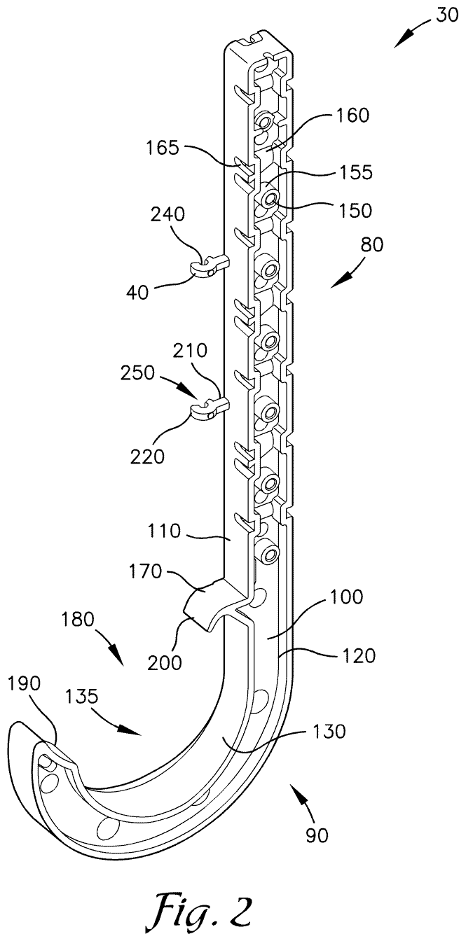

FIG. 1 shows an embodiment of the J-hanger 30 with two integrally formed fastener holders 40 that each include a fastener 42 releasably molded therein. FIG. 2 shows the J-hanger 30 with the fasteners 42 removed or released from the fastener holder 40. The J-hanger 30 is configured to secure conduit to a support structure, such as a floor joist, but may be used for a variety of other installations.

The J-hanger 30 includes a mounting stem 80 for securing the J-hanger 30 to the support structure and a bracket or conduit cradle 90 extending from an end of the stem 80 and configured to support the conduit. The mounting stem 80 and the conduit cradle 90 are formed having an I-shaped cross section that includes a web 100 extending between an inner flange 110 and an outer flange 120. The flanges 110 and 120 are spaced apart by the web 100. The I-shaped cross section maximizes the strength and the rigidity of the J-hanger 30 and minimizes the material used and the weight of the J-hanger 30. The inner flange 110 extends inside of the conduit cradle 90 and forms a conduit engaging surface 130. The conduit engaging surface 130 of the conduit cradle 90 forms an opening or channel 135 through which the conduit is extendable. The outer flange 120 extends substantially parallel to the inner flange and on an outer surface of the conduit cradle 90.

In an embodiment, a plurality of fastener receiving holes 150 are formed in the web 100 in spaced apart relation along the mounting stem 80. A reinforcing boss 155 formed integrally with the web 100 surrounds each of the holes 150. Fasteners 42 insertable through selected ones of the holes 150 are used to secure the stem 80 to a substrate, such as a joist, to secure the J-hanger 30 to the substrate in a first position, with the conduit extending through the channel 135 and supported by the conduit engaging surface 130, substantially perpendicular to the substrate. In an embodiment, a plurality of notches 160 extend in the web 100 and between the flanges 110 and 120 form a plurality of holes 165 in the inner flange 110 and outer flange 120 such that fasteners 42 extendable through the holes 165 are securable to the substrate to secure the J-hanger 30 thereto in a second position with the conduit extending substantially parallel to the substrate. In an embodiment, the plurality of notches 160 are formed such that the fasteners 42 are extendable horizontally and/or angularly between the flanges 110 and 120.

The conduit cradle 90 is configured such that a diameter of the channel 135 is equal to or greater than an outer diameter of the conduit. In an embodiment, the conduit cradle 90 includes a flexible locking device or barb 170 positioned on the inner flange 110 and extending over the channel 135 formed by the conduit cradle 90. An opening 180 to the channel 135 is formed between the flexible locking device 170 and an end 190 of the inner flange 110 of the conduit cradle 90. In an embodiment, the opening 180 has a dimension that is less than the outer diameter of the conduit, and to secure the conduit in the conduit cradle 90 the conduit is positioned laterally across the opening 180 between the end 190 the conduit cradle 90 and a finger 200 of the flexible locking device 170, and pressure is applied to the conduit to force the finger 200 radially inward or down and force the end 190 outward such that the opening 180 expands to allow the conduit to be advanced into and secured in the channel 135 formed in the conduit cradle 90. After the conduit is snapped into place, the end 190 and the finger 200 return to their original positions, securing the conduit in the conduit cradle 90. Alternatively, an end of the conduit can be guided through the opening 135 of the conduit cradle 90 or a conduit having a diameter smalling than the opening 180 can be placed within the channel 135 to be supported on the conduit engaging surface 130.

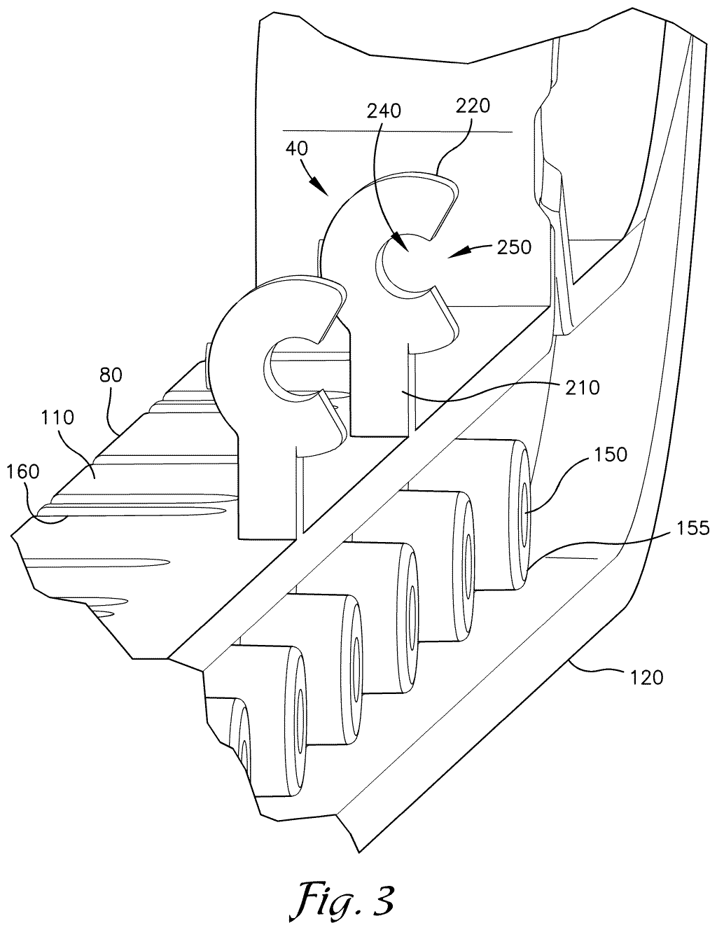

In the embodiment shown, two fastener holders 40 are formed on the inner flange 110, but it is foreseeable that one or more fastener holders 40 could be formed on or positioned on another surface of the J-hanger 30, such as on the outer flange 120 or on the web 100. As shown in FIG. 3, each fastener holder 40 includes a connecting structure or tab 210 connected to or formed integrally with the mounting stem 80 and a fastener cradle 220 extending from the connecting structure 210. The fastener cradle 220 is formed around and engages the fastener 42 as shown in FIG. 1 (in FIG. 3 the fasteners 42 have been removed). In an embodiment, the connecting structure 210 extends from the inner flange 110, on a side of the inner flange 110 opposite the plurality of notches 160 or on an outside of the inner flange 110, such that the fastener 42 when releasably molded in the fastener cradle 220 does not interfere with the device 30 or with the process of molding the device.

As shown in the embodiment in FIG. 1, the fastener cradle 220 is formed to releasably secure the fastener 42 to the J-hanger 30 and extends at least 180° around a shaft 230 of the fastener 42, and preferably between at least 180° to approximately 220° around a shaft 230 of the fastener 42, or even more preferably approximately 200° degrees around the shaft 230 of the fastener 42, such that the fastener 42 is securely retained in the fastener cradle 220 absent the application of a sufficient force on the fastener 42 to remove the fastener 42 from the fastener cradle 220.

Removal of the fastener 42 from the fastener cradle 220 creates a circular recess or cavity 240 surrounded by the fastener cradle 220 and having a diameter equal to or slightly greater than a diameter of the shaft 230 of the fastener 42 with an access slot 250 extending outward from the cavity 240 between opposed ends of the fastener cradle 220 and through which the fastener 42 is removable. The force required to separate the fastener 42 from the fastener holder 40 or fastener cradle 220 is large enough to secure the fastener 42 therein during transport and storage, but small enough to allow a user to manually separate the fastener 42 from the fastener cradle 220 by grasping the fastener 42 and pulling the fastener 42 through the slot 250 of the fastener holder 40.

In an embodiment, the connecting structure 210 is configured such that a user may break or separate the fastener holder 40 from the device 30 by breaking or cutting the fastener cradle 220 and fastener 42 away from the connecting structure 210 if required and with the fastener 42 remaining secured within the fastener cradle 220. It is foreseen that the fastener cradle 220 could be formed to completely surround the fastener 42 and be left on the fastener 42 when the fastener cradle 220 and fastener are separated from the connecting structure 210. It is also foreseen that the connecting structure 210 could be formed thinner at a junction of the connecting structure 210 with the fastener cradle 220 to facilitate manual separation of the fastener cradle 220 from the connecting structure 210. Similarly, the connecting structure 210 could be formed thinner at a junction of the connecting structure 210 with the inner flange 110 of the J-hanger 30 to facilitate manual separation of the connecting structure 210 from the J-hanger 30.

The fastener 42, when separated from the device, such as J-hanger 30, is useable to secure the device 30 to a substrate. The fastener 42 shown in the embodiments may be a nail, a screw, a bolt, or an equivalent thereof.

Referring to FIGS. 4 and 5, the tubing hanger 35 is adapted to suspend or support conduit, but may be used for a variety of other installations. The tubing hanger 35 includes an embodiment of a fastener holder 510 with at least a portion of a shaft 230 of a fastener 42 releasably molded therein and a cradle 590 projecting from one side of the fastener holder 510 and configured to support a conduit. The fastener holder 510 is integrally formed with the cradle 590.

The cradle 590 is formed by a pair of curved arms or claws 592 and 593 projecting outward from the fastener holder 510. Each claw 592 and 593 is formed with an I-shaped cross section that includes a web 600 extending between an inner flange 610 and an outer flange 620. The flanges 610 and 620 are spaced apart by the web 600. The I-shaped cross section maximizes the strength and rigidity of the tubing hanger 35 and minimizes the material used and the weight of the tubing hanger 35.

The inner flange 610 extends within and is an inner surface of the claws 592 and 593 and forms an opening 635 for the conduit to extend therethrough. In an embodiment, the inner flange 610 is a conduit engaging surface. In an embodiment, the inner flange 610 includes reinforcing segments 640 to strengthen the inner flange 610 and position the conduit in the opening 635 relative to the inner flange 610. The outer flange 620 is an outer surface of the tubing hanger 35.

In an embodiment, the cradle 590 is configured such that a diameter of a circle circumscribing the inner edge of each of the reinforcing segments 640 is approximately equal to or greater than an outer diameter of the conduit to be secured therein. In an embodiment, an opening or gap 645 is formed between the distal ends of the claws 592 and 593 through which a conduit may be pressed or inserted into the opening or receiver 635 of the cradle 590. In an embodiment, the claws 592 and 593 are preferably sufficiently flexible to allow the claws 592 and 592 to bend outwards and away from each other as the conduit is pressed into the cradle 590 through the gap 645 between the claws 592 and 593.

The fastener holder 510 may also be referred to as a base 510 of the hanger 35 from which the cradle 590 projects on one side thereof. The base or fastener holder 510 at least partially surrounds the fastener 42. In the embodiment shown in FIG. 4, the base 510 is on a side of the cradle 590 opposite the gap 645 between claws 592 and 593, but the base 510 could also extend on one or both of the sides of the cradle 590 that are adjacent to the side including the gap 645. The fastener 42 is releasably molded into the base 510 by a molding process, and in an embodiment, portions of the mold form recesses 655 extending into the base 510 from opposite sides thereof in an alternating spaced relationship such that successive longitudinally extending portions of the fastener are covered by plastic on one side of the base 510 but not the other to form a cradle or frame that secures the fastener therein. The sections of plastic covering the fastener 42 in the base 510 may be referred to as reinforcing elements 660. Engagement of portions of the fastener 42 by the reinforcing elements 660 of the base 510 is sufficient to secure the fastener 42 therein during transport and storage, but a bond or adhesion of the plastic of the reinforcing elements 660 to the fastener 42 is broken by driving the fastener 42 with a hammer or the like in a direction generally transverse to the bond between the fastener 42 and the reinforcing elements 660 to drive the fastener into a substrate to secure the tubing hanger 35 thereto.

The process of molding a device 30 with a fastener 42 secured within a fastener holder 40 is described herein. The process of molding the device 30 is described relative to an injection molding process for a J-hanger 30, but it is understood that the process could be applied to another type of molding process, or the process could be applied to form another type of device.

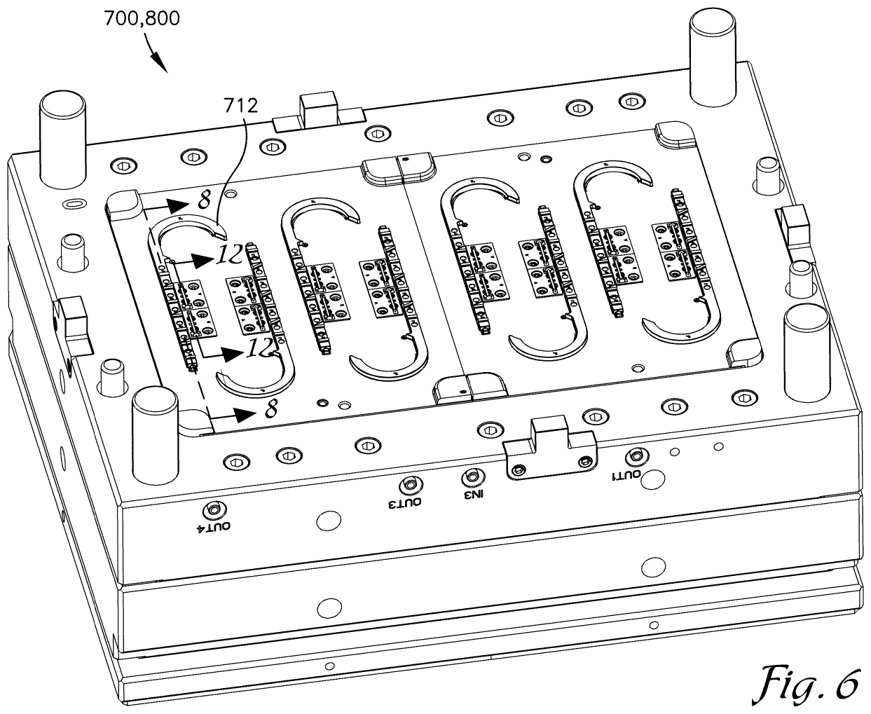

The hanger 30 including the integrally formed fastener holder 40 is formed and defined by a first mold plate 700 and a second mold plate 702. The hanger 35 with integrally formed fastener holder or base 510 may also be formed by first and second mold plates (not shown). The first mold plate 700, shown in FIGS. 6-8 and 12, forms a first side or portion of a cavity 705 that defines the J-hanger 30 and includes a raised section 712 and a first fastener cradle recess or first fastener holder recess 714. The raised section 712 defines the first side of the mounting stem 80 and the conduit cradle 90 of the J-hanger 30, and the first fastener cradle recess 714 defines a first portion of the fastener cradle 220 of the fastener holder 40 that includes the opposed ends of the fastener cradle 220 and the slot 250 extending therebetween.

The first mold plate 700 includes one or more first chambers 715 that receive the one or more fasteners 42 and means for maintaining the one or more fasteners 42 in position in the one or more first chambers 715 during the molding process. In an embodiment, the means for maintaining the one or more fasteners 42 in position ensures accuracy in molding the fastener holder 40 and stability of the fastener 42 during the molding process. In an embodiment, the means for maintaining the one or more fasteners 42 in position includes one or more magnets 716 that engage the fasteners 42 and at least partially surround the fasteners 42. Alternatively, or additionally, means for maintaining the one or more fasteners 42 in position may include one or more of a suction device, a gripping device, a clamp, a bracket, a sleeve, a guide, and/or an equivalent device or method, and such means may be formed integrally with or coupled to the first mold plate 700 and/or a second mold plate 702.

Each first chamber 715 is formed in the first mold plate 700 as a depression to contain the fastener 42 therein and includes a first head depression section 720 that is configured for containing a head 722 of the fastener 42 and a first shaft depression section 724 that is configured for containing a shaft 230 of the fastener 42. The first head depression section 720 and the first shaft depression section 724 are formed such that the fastener 42 may be inserted into the first chamber 715 in a range of longitudinal positions, providing flexibility in inserting the fastener 42 therein and providing flexibility as to a size and shape of the head 722 of the fastener 42 and a length of the shaft 230 of the fastener. 42. The first shaft depression section 724 of each first chamber 715 extends through a center of the first fastener cradle recess 714 such that the first portion of the fastener cradle 220 of the fastener holder 40 formed therein engages a portion of the fastener 42 that extends through the first cradle recess 714, and the fastener holder 40 is molded to at least partially surround the fastener 42 during the molding process.

Each fastener 42 is also positioned on top of or adjacent to a slot core 730 within the first fastener cradle recess 714 that defines the opposed ends of the fastener cradle 220 of the associated fastener holder 40 and the slot 250 extending therebetween. The slot core 730 is formed within and generally divides or separates the first fastener cradle recess 714 in two sections. Positioning he fastener 42 on top of or adjacent the slot core 730 prevents or at least minimizes plastic from flowing and solidifying between the fastener 42 and the slot core 730 to form the slot 250 of the fastener cradle 220 through which the fastener 42 is releasable or removable.

In the embodiment shown, two magnets 716 extend at least partially around the shaft 230 of each fastener 42 and are each secured in a respective first receptacle 750 in the first mold plate 700. The first receptacles 750 intersect with the first shaft depression section 724 of the first chamber 715 such that the magnets 716 positioned therein engage the shaft 230 of the fastener 42 that extends through the first shaft depression section 724. Alternatively, the magnets 716 may be positioned in the second mold plate 702 to engage the fasteners 42. The magnets 716 secure the fastener 42 against the slot core 730.

The second mold plate 702, shown in FIGS. 9-11 and 13, forms a second side or portion of the cavity 705 that defines the J-hanger 30 and includes a recessed section 751 and a second cradle or fastener holder recess 752. The recessed section 751 defines the second portion of the mounting stem 80 and the conduit cradle 90 of the J-hanger 30, and the second fastener holder recess 752 includes a connecting structure recess 753 that defines the connecting structure 210, and a second cradle recess 754 that defines a second portion of the fastener cradle 220 of the fastener holder 40 that extends around one side of the shaft 230 of the fastener 42.

The second mold plate 702 is formed with one or more second chambers 758 that each correspond to the one or more first chambers 715 that contain the one or more fasteners 42 in the first mold plate 700. Each second chamber 758 is formed as a depression that includes a second head depression section 760 that corresponds the first head depression section 720 and a second shaft depression section 762 that corresponds to the first shaft depression section 724. The second shaft depression section 762 extends through the second cradle recess 754 such that when the mold is closed or the mold plates 700 and 702 are advanced into abutting relationship the fastener 42 positioned on the slot core 730 extends through the second cradle recess 754 in the second mold plate 702. The magnets 716 in the first mold plate 700 position the fastener 42 within the first chamber 715 in the first mold plate 700 and the second chamber 758 of the second mold plate 702 during the molding process such that the fastener holder 40 is molded to at least partially surround the fastener 42.

Each magnet 716 secured in the one or more first receptacles 750 also extends into second receptacles 770 formed in the second mold plate 702 such that the fastener 42 secured therein extends through a center of the first chamber 715 and the second chamber 758 when the first mold plate 700 and second mold plate 702 are advanced into abutting relationship or closed during the molding process.

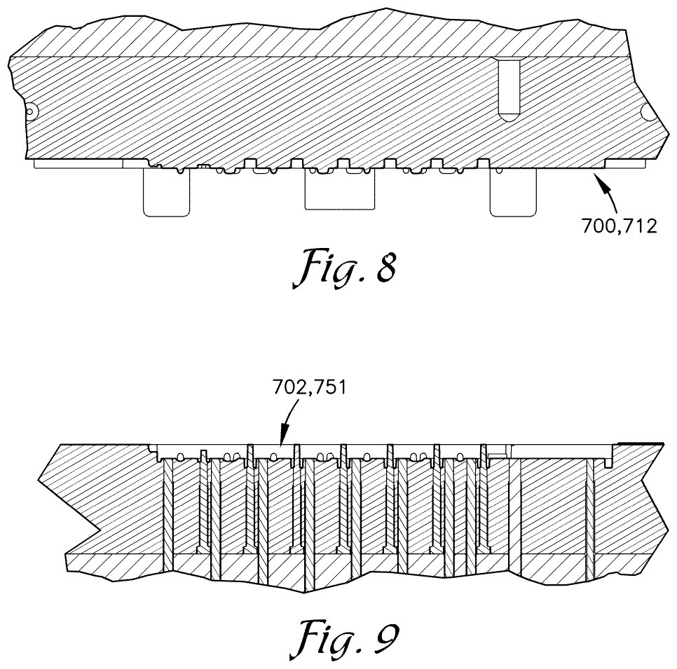

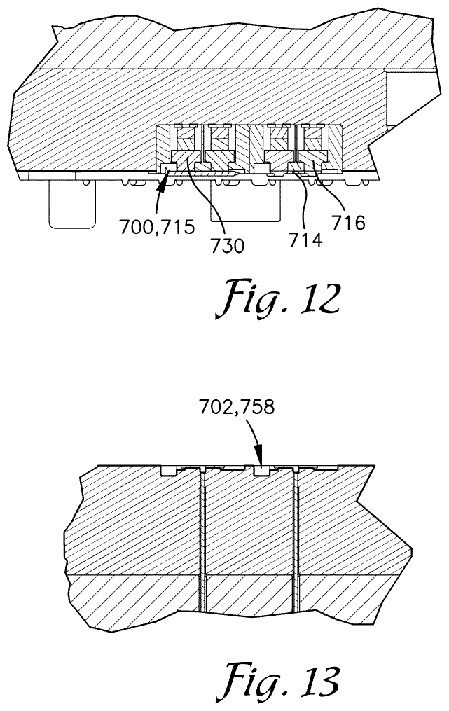

In the embodiments shown in FIGS. 8 and 9, the first mold plate 700 and the second mold plate 702 have a mating relationship when advanced together to form the cavity 705. The first mold plate 700 and the second mold plate 702 are closed and clamped together to form the cavity 705 that is configured such that during a molding process a plastic material is able to flow therethrough to form the J-hanger 30 integrally formed with the one or more fastener holders 40 formed around the one or more fasteners 42. Each of the plates 700 and 702 include complementary or corresponding sections as described herein. The mold plates 700 and 702 include the raised section 712 and the recessed section 751, respectively, that form the mounting stem 80 and the conduit cradle 90 of the J-hanger 30 during the molding process. The mold plates 700 and 702 include the first fastener cradle recess 714 and the second fastener cradle recess 752, respectively, that form fastener holder 40 formed around the fastener 42 during the molding process. In the embodiments shown in FIGS. 12 and 13, the first mold plate 700 and the second mold plate 702 have a mating relationship when advanced together to form the fastener receiving chambers 715 and 758. The chambers 715 and 758 through which the fasteners 42 extend and the receptacles 750 and 770 for the magnets 716 are not flow connected to the cavity 705 and the fastener holder recesses 714 and 752. The orientation of the first and second mold plates 700 and 702 in FIGS. 8 and 9 and FIGS. 12 and 13 respectively is for illustrative purposes only with the mold plate 700 in FIGS. 8 and 12 spaced above the mold plate 702 in FIGS. 9 and 13 respectively to show how portions of the mold plates 700 and 702 align. It is to be understood that the first and second mold plates 700 and 702 would likely be oriented to extend vertically in a mold to facilitate ejection of a molded part therefrom.

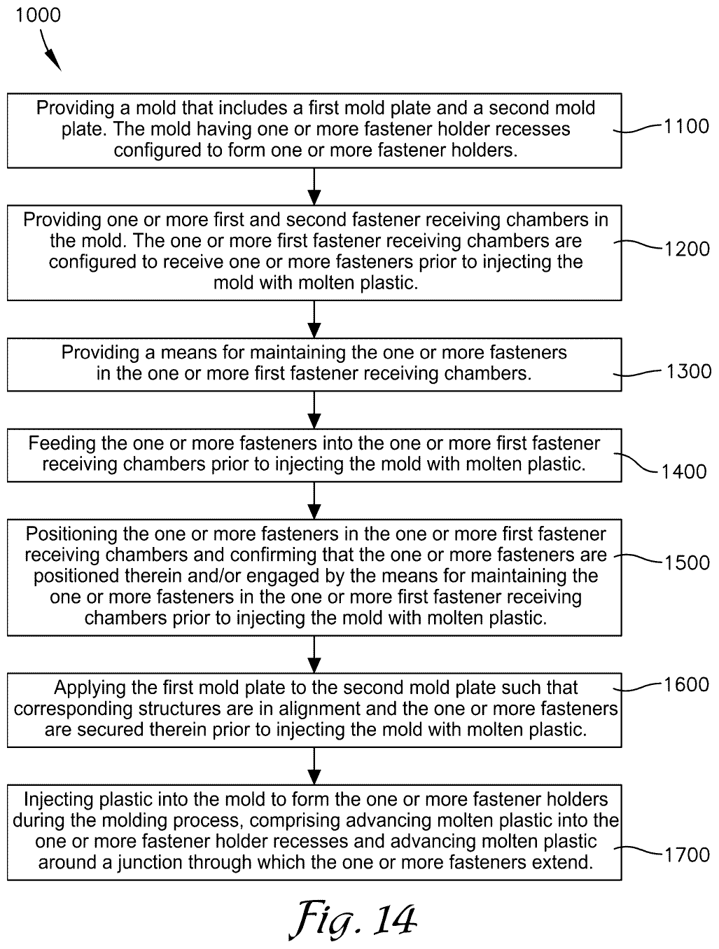

The process or method 1000 of molding a device 30 with a fastener 42 secured within a fastener holder 40 is described herein and shown in FIG. 14. The process 1000 of molding the device 30 is described relative to an injection molding process for a J-hanger 30, but it is understood that the process could be applied to another type of molding process or the process could be applied to form another type of device or another type of material could be used to form the device.

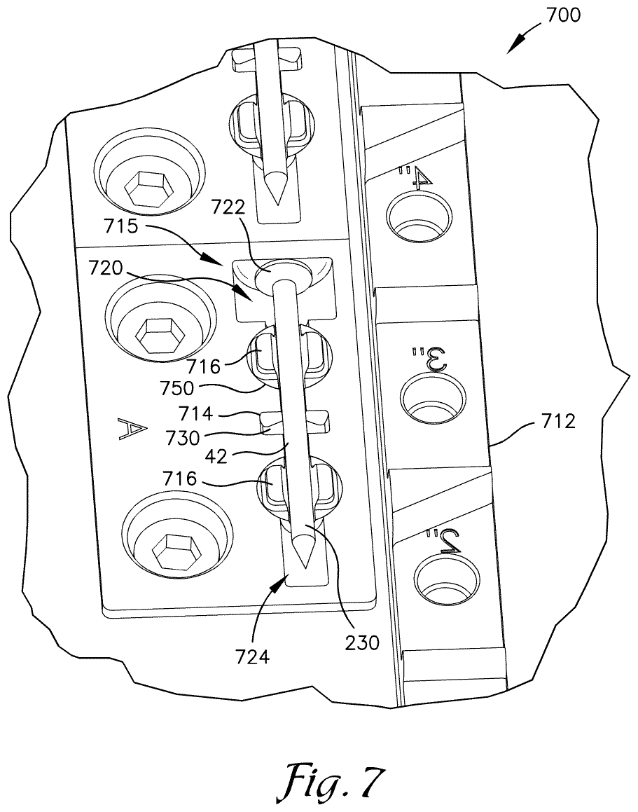

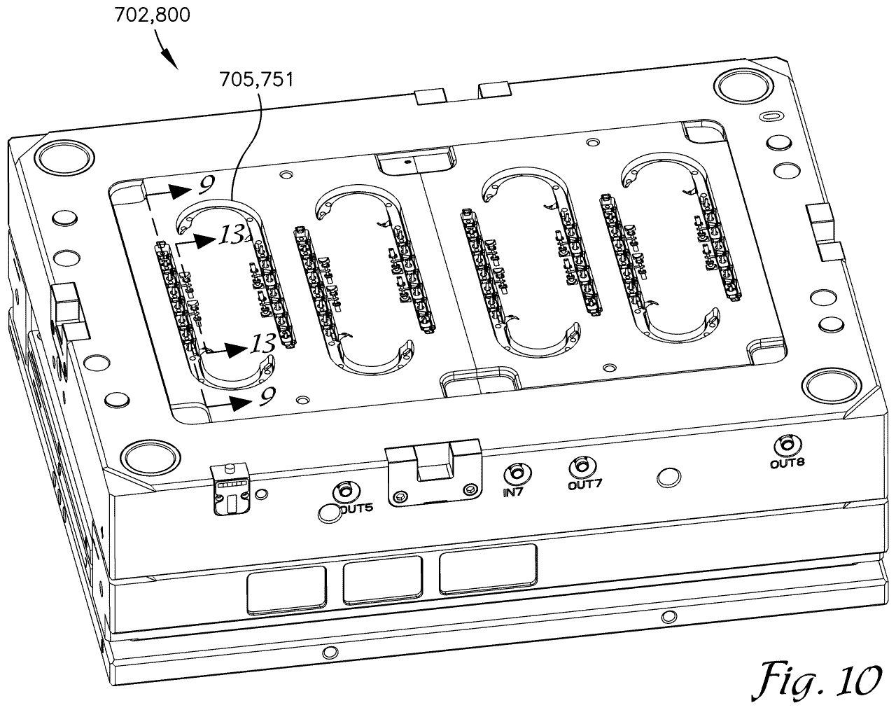

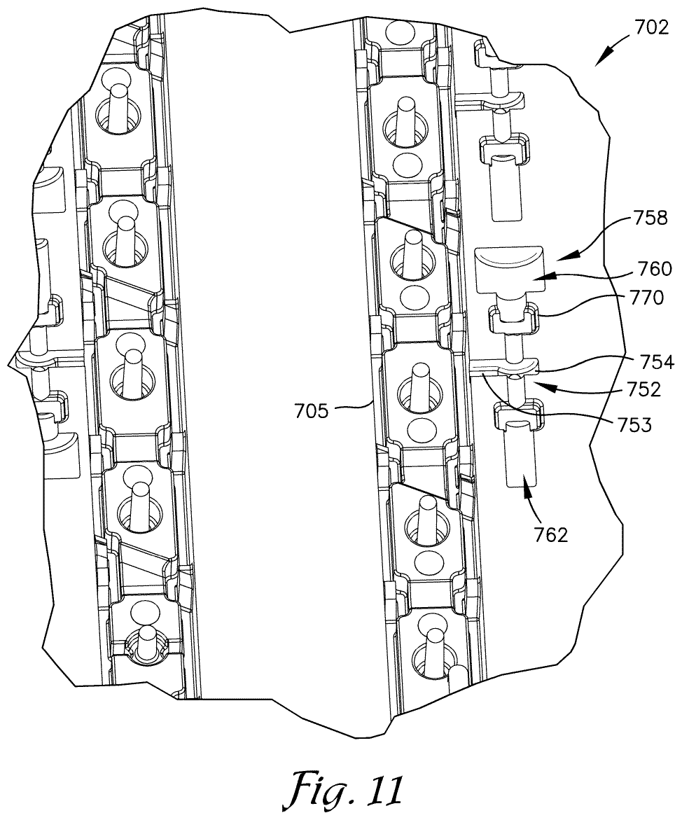

In an embodiment, the process 1000 includes a step 1100 of providing tooling or a mold 800 that includes the first mold plate 700 shown in FIGS. 6 and 7, which is formed with the first chamber 715 for receiving the fastener 42 therein, and the second mold plate 702 shown in FIGS. 10 and 11, which is formed with the second chamber 758 that corresponds to and aligns with the first chamber 715 when the first mold plate 700 and second mold plate 702 are advanced into abutting relationship or closed during the molding process. The mold 800 forms the cavity 705 that defines the J-hanger 30 formed integrally with one or more fastener holders 40 formed around a fastener 42 releasably molded therein. The mold 800 may have multiple cavities 705 for forming multiple J-hangers 30 simultaneously. The mold 800 is configured such that an injection unit injects molten plastic into the cavity 705 and/or the fastener holder recesses 714 and 752 that defines the J-hanger 30 and the fastener holders 40, respectively. In an embodiment, the mold 800 is utilized in a horizontal position with the first mold plate 700 positioned on top of the second mold plate 702, but it is foreseeable that the mold 800 may be utilized in a vertical position or in a position with the second mold plate 702 positioned on top of the first mold plate 700.

The process 1000 includes a step 1200 of providing one or more first and second chambers 715 and 758 in the mold 800 that are configured to receive a fastener 42 that is placed in the respective first chamber 715 of the first mold plate 700 prior to injection of molten plastic into the mold 800.

The process 1000 of molding the J-hanger 30 includes a step 1300 of providing one or more magnets 716 that are secured in each first receptacle 750 in the first mold plate 700 and configured to maintain each fastener 42 in at least the associated first chamber 715 during the molding process.

The process 1000 further includes a step 1400 of feeding a fastener 42 into each first chamber 715 provided in the first mold plate 700 prior to injection of molten plastic into the mold 800. The fastener 42 may be fed manually into each first chamber 715 of the first mold plate 700 or this step may be automated, such as by a robotic process. Alternatively, each fastener 42 may be fed into a fastener chamber for containing the fastener in the second mold plate 702.

The process 1000 of molding the device 30 may include a step 1500 of confirming that each fastener 42 is positioned within an allowable tolerance specification in the corresponding first chamber 715 such that the fastener 42 is engaged by the one or more magnets 716 in the first mold plate 700 prior to injection of into the mold 800.

The process 1000 of molding the device 30 may include a step 1600 of advancing the first mold plate 700 into abutting relationship with the second mold plate 702 or aligning the first and second mold plates 700 and 702 such that the corresponding structures are in alignment and the fastener 42 is secured within the first and second chambers 715 and 758 prior to injecting plastic in the cavity 705 and/or the fastener holder recesses 714 and 752 of the mold 800 to form the fastener holder 40 around the fastener 42.

The process 1000 includes a step 1700 of injecting plastic into the mold 800 to form a device having the one or more fasteners 42 releasably molded into one of the one or more fastener holders 40 during the molding process. The step 1700 comprises at least: clamping the first mold plate 700 to the second mold plate 702; attaining a molding condition for optimal injection molding; melting a plastic; injecting or advancing molten plastic, such as by a screw that controls an injection speed of the molten plastic, such that the molten plastic flows into the cavity 705 and the fastener holder recesses 714 and 752 and around the fastener 42 extending between the first mold plate 700 and the second mold plate 702; applying a pressure to the mold to ensure the cavity 705 and fastener holder recesses 714 and 752 are filled with the molten plastic; cooling the device 30 produced by the process such that the plastic solidifies; unclamping and separating the first mold plate 700 from the second mold plate 702; and ejecting the device 30.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and sub-combinations are of utility and may be employed without reference to other features and sub-combinations and are contemplated within the scope of the claims.

What is claimed is:

1. A method of molding a device to be distributed with one or more fasteners, the method comprising:
providing a mold having one or more cavities configured to define the device and one or more fastener holders integrally formed therewith;
providing one or more fastener receiving chambers formed in the mold that are configured to contain the one or more fasteners;
feeding the one or more fasteners into the one or more fastener receiving chambers; and
injecting a material into the mold subsequent to feeding the one or more fasteners into the one or more fastener receiving chambers, wherein the one or more fasteners are releasably molded therein.

2. The method of claim 1, further comprising providing means for maintaining the one or more fasteners in the one or more fastener receiving chambers.

3. The method of claim 2, wherein the one or more fasteners are formed from a ferromagnetic material and the means for maintaining the one or more fasteners in the one or more fastener receiving chambers comprises one or more magnets secured within one or more magnet receiving receptacles.

4. The method of claim 3, wherein the one or more magnets extend at least partially around the one or more fasteners.

5. The method of claim 2, further comprising positioning the one or more fasteners relative to the means for maintaining the one or more fasteners in the one or more fastener receiving chambers and confirming that the one or more fasteners are positioned therein and engaged thereby prior to injecting the material into the one or more cavities in the mold.

6. The method of claim 1, wherein the mold comprises a first mold plate and a second mold plate and the one or more fastener receiving chambers are formed in the first mold plate, and the method further comprises advancing the first mold plate into abutting relationship with the second mold plate with the one or more fasteners secured therein.

7. The method of claim 1, wherein the mold comprises a first mold plate and a second mold plate, and the first mold plate includes a first portion of each of the one or more fastener receiving chambers configured to receive the one or more fasteners and the second mold plate includes a second portion of each of the one or more fastener receiving chambers.

8. The device to be distributed with one or more fasteners molded therein made by the method of claim 1.

9. The device to be distributed with one or more fasteners molded therein as in claim 8, wherein the device comprises a hanger for supporting a conduit having one or more fastener receiving holes formed therein and the one or more fasteners comprise a nail or a screw.

10. A method of molding a device to be distributed with one or more fasteners, the method comprising:
separating a first mold plate and a second mold plate of a mold, the first mold plate and the second mold plate forming one or more cavities configured to define the device and one or more fastener holders integrally formed therewith when the first and second mold plates are advanced into abutting relationship, wherein a first portion of one or more fastener receiving chambers is formed in the first mold plate and configured to receive the one or more fasteners when the first and second mold plates are separated and a second portion of the one or more fastener receiving chambers is formed in the second mold plate, wherein when the first and second mold plates are advanced into abutting relationship, each of the one or more fastener receiving chambers extends through and opens into the one or more cavities configured to define the one or more fastener holders;
feeding the one or more fasteners into the first portion of each of the one or more fastener receiving chambers when the first and second mold plates are separated;
advancing the first and second mold plates into abutting relationship;
injecting a plastic material into the one or more cavities of the mold to form the device and the one or more fastener holders integrally formed therewith, wherein the one or more fasteners are releasably molded in the one or more fastener holders;
advancing the first and second mold plates to a separated position; and
ejecting from the mold the device with the one or more fasteners secured in the one or more fastener holders integrally formed with the device.

11. The method of claim 10, further comprising providing a means for maintaining the one or more fasteners in the one or more fastener receiving chambers.

12. The method of claim 11, wherein the one or more fasteners are formed from a ferromagnetic material and the means for maintaining the one or more fasteners in the one or more fastener receiving chambers comprises one or more magnets secured within one or more magnet receiving receptacles.

13. The method of claim 12, wherein the one or more magnets extend at least partially around the one or more fasteners.

14. The method of claim 11, further comprising positioning the one or more fasteners relative to the means for maintaining the one or more fasteners in the one or more fastener receiving chambers, and confirming that the one or more fasteners are positioned therein and engaged thereby prior to injecting material into the mold.

15. The device to be distributed with one or more fasteners molded therein made by the method of claim 10.

16. The device to be distributed with the one or more fasteners molded therein as in claim 15, wherein the device comprises a hanger for supporting a conduit, the device having one or more fastener receiving holes formed therein and the one or more fasteners comprise a nail or a screw.

17. A device having a fastener molded therein, the device comprising:
a hanger configured to support a conduit; and
one or more fastener holders extending from the hanger and formed integrally therewith, the one or more fastener holders including one or more fasteners releasably molded therein during a molding process.

18. The device of claim 17, wherein the one or more fastener holders extend around a portion of the one or more fasteners to secure the one or more fasteners therein.

19. The device of claim 18, wherein the one or more fastener holders extend more than 180° around the one or more fasteners.

20. The device of claim 17, wherein one or more fastener cradles of the one or more fastener holders are formed extending around and engaging the one or more fasteners, and the one or more fastener cradles securely retain the one or more fasteners therein until forcibly removed therefrom.

21. The device of claim 17, further comprising at least one fastener receiving hole formed therein that is configured such that the one or more fasteners are drivable therethrough to secure the device to a substrate.

22. A mold for forming a device with a fastener, the mold comprising:
one or more fastener receiving chambers formed therein and configured to receive one or more fasteners; wherein:
each of the one or more fastener receiving chambers extends therethrough and opens into one or more fastener holder cavities configured to define one or more fastener holders that are formed around the one or more fasteners during a molding process.

23. The mold of claim 22, further comprising a first mold plate and a second mold plate, wherein the first mold plate includes a first portion of the one or more fastener holder cavities, and the second mold plate includes a second portion of the one or more fastener holder cavities.

24. The mold of claim 22, wherein the one or more fastener holder cavities are configured to form the one or more fastener holders extending more than 180° around the one or more fasteners.

25. The mold of claim 22, further comprising a first mold plate and a second mold plate and the one or more fastener receiving chambers are formed in the first mold plate.

26. The mold of claim 22, further comprising a first mold plate and a second mold plate, and the first mold plate includes a first portion of each of the one or more fastener receiving chambers configured to receive the one or more fasteners and the second mold plate includes a second portion of each of the one or more fastener receiving chambers.

27. The mold of claim 22, further comprising one or more magnets secured relative to the one or more fastener receiving chambers to secure the one or more fasteners therein.
